(19) United States
(12) Patent Application Publication
(10) Pub. No.: US 2010/0237037 A1
(43) Pub. Date: Sep. 23, 2010

(54) Ceramic substrate metalization process

(75) Inventors: Wen-Hsin Lin, Taipei City (TW); Chi-Jen Liu, Pingjhen City (TW)

Correspondence Address: BACON & THOMAS, PLLC, 625 SLATERS LANE, FOURTH FLOOR, ALEXANDRIA, VA, 22314-1176, US

(73) Assignee: HOLY STONE ENTERPRISE CO., LTD., Taipei City (TW)

(21) Appl. No.: 12/461,279

(22) Filed: Aug. 6, 2009

(30) Foreign Application Priority Data
Mar. 19, 2009 (TW) 098108995

(51) Int. Cl. B44C 1/22; B05D 1/04

(52) U.S. Cl. 216/13; 427/474

(57) ABSTRACT

A ceramic substrate metallization process for making a ceramic circuit substrate practically in an economic way by means of: washing a non-charged ceramic substrate and roughening the surface of the ceramic substrate by etching, and then coating a negatively charged (or positively charged), silicon-contained, nanoscaled surface active agent on the ceramic substrate, and then coating a positively charged (or negatively charged) first metal layer on the ceramic substrate.

### BACKGROUND OF THE INVENTION

This application claims the priority benefit of Taiwan patent application number 098108995 filed on Mar. 19, 2009.

1. Field of the Invention

The present invention relates to the fabrication of a ceramic circuit substrate and more particularly, to a ceramic substrate metallization process to form a metal layer on the surface of a non-charged ceramic substrate by means of roughening the surface of the ceramic substrate and then coating the roughened surface of the ceramic substrate with a nanoscaled surface active agent and then depositing a thin film of metal on the ceramic substrate by means of a coating technique.

2. Description of the Related Art

Following the development of technology and the desire of people to seek a better life, application of products has become more and more critical. In consequence, new materials have been continuously created to satisfy market requirements. Manufacturers keep investing money to fabricate IC packages having better transmission and heat dissipation efficiency with smaller package size for use in mobile electronic products (cell phone, mini notebook, etc.). Nowadays, ceramic substrate has been intensively used to substitute for other conventional substrate materials for making electronic devices for the advantages of good electrical insulation, high chemical stability, excellent electro-magnetic characteristics, high hardness, and high wear resistance and temperature resistance characteristics. However, the circuit layer of a ceramic circuit substrate is formed by means of a thermo compression technique to bond a metal material on the surface of the prepared ceramic substrate. According to this method, the circuit layer has a certain thickness, and copper oxide tends to be formed in the junction, causing a sharp rise in thermal resistance. If a thin film metal circuit layer is made, the circuit layer may break during thermal compression, lowering the product quality and increasing the manufacturing cost.

Accordingly, there is a continuous need for metallization of a ceramic substrate that eliminates the aforesaid problem.

### SUMMARY OF THE INVENTION

The present invention has been accomplished under the circumstances in view. According to one aspect of the present invention, a non-charged ceramic substrate (for example, ALN/A1203/LTCC/BaTiO3) is prepared and washed with pure water, and then the surface of the cleaned ceramic substrate is roughened by means of an etching technique, and then a negatively charged silicon-contained, nanoscaled surface active agent is coated on the roughened surface of the ceramic substrate, and then a positively charged first metal layer (for example, Si/Ni/Cr, Fe/Co or Fe/Co/Ni) is coated on the ceramic substrate by means of a coating technique. This fabrication method is simple and economic. By means of positive-negative charge attraction, the first metal layer is positively bonded to the ceramic substrate.

According to another aspect of the present invention, a second metal layer is coated on the first metal layer, and then a dry film is covered on the second metal layer, and then an etching technique is employed to etch the dry film, the second metal layer and the first metal layer subject to a predetermined circuit pattern, and then a coating technique is employed to coat a metal material on the patterned second metal layer subject to a predetermined thickness. Thus, a ceramic circuit substrate is made having high conductivity and heat dissipation characteristics. Further, the coating technique can be vacuum deposition, chemical vapor deposition, sputter deposition or chemical plating.

### BRIEF DESCRIPTION OF THE DRAWINGS

FIG. 1 is a flow chart of a ceramic substrate metallization process in accordance with the present invention.

FIG. 2 is a detailed flow chart of the ceramic substrate metallization process in accordance with the present invention.

FIG. 3 illustrates the fabrication of a ceramic circuit substrate according to the present invention (I).

FIG. 4 illustrates the fabrication of a ceramic circuit substrate according to the present invention (II).

### DETAILED DESCRIPTION OF THE PREFERRED EMBODIMENT

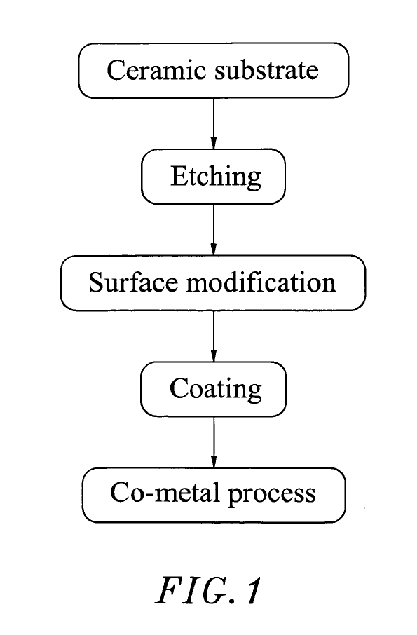

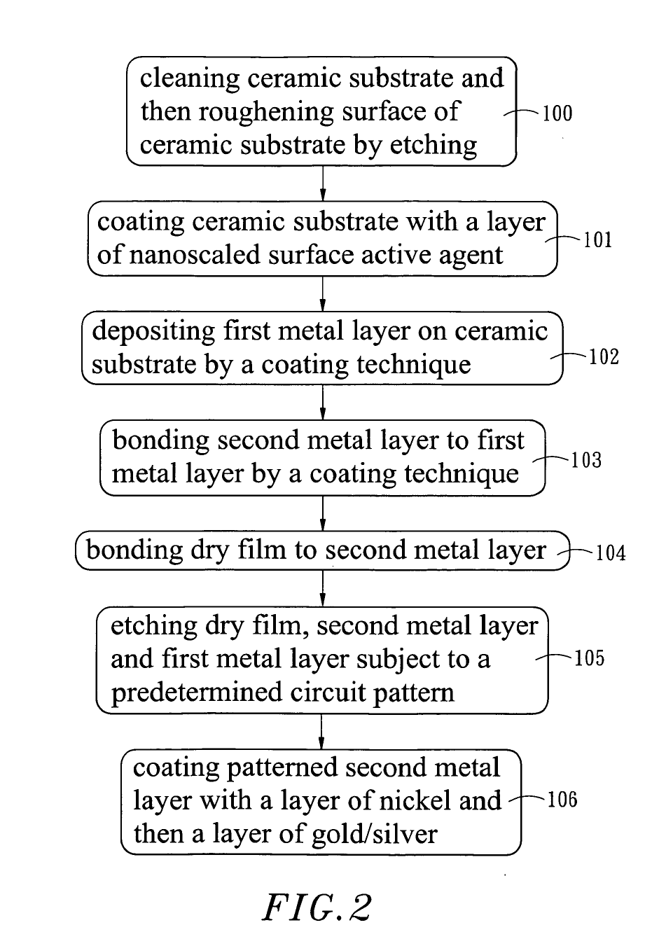

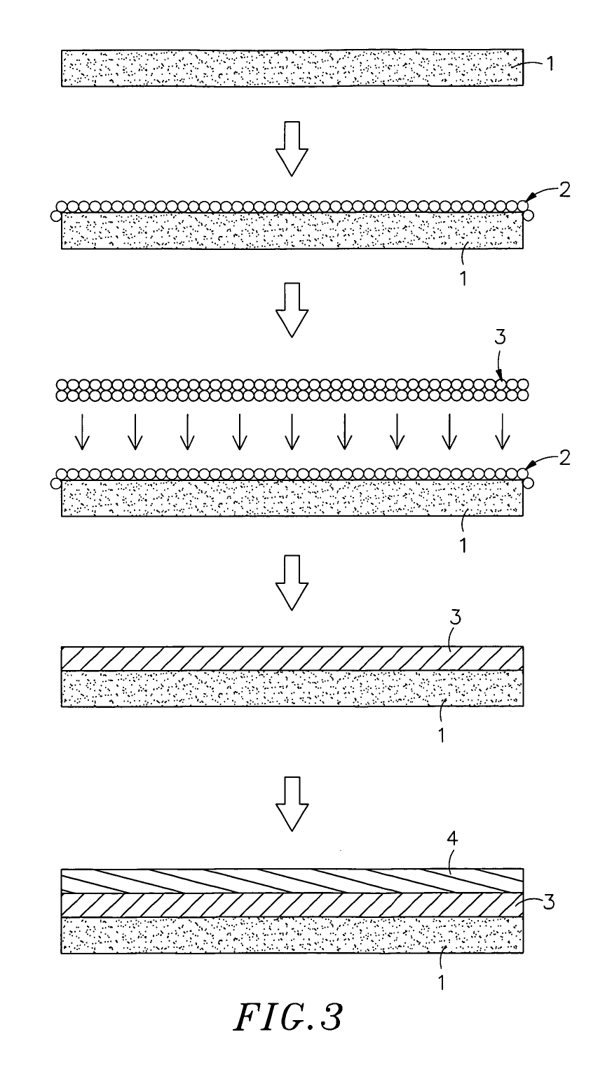

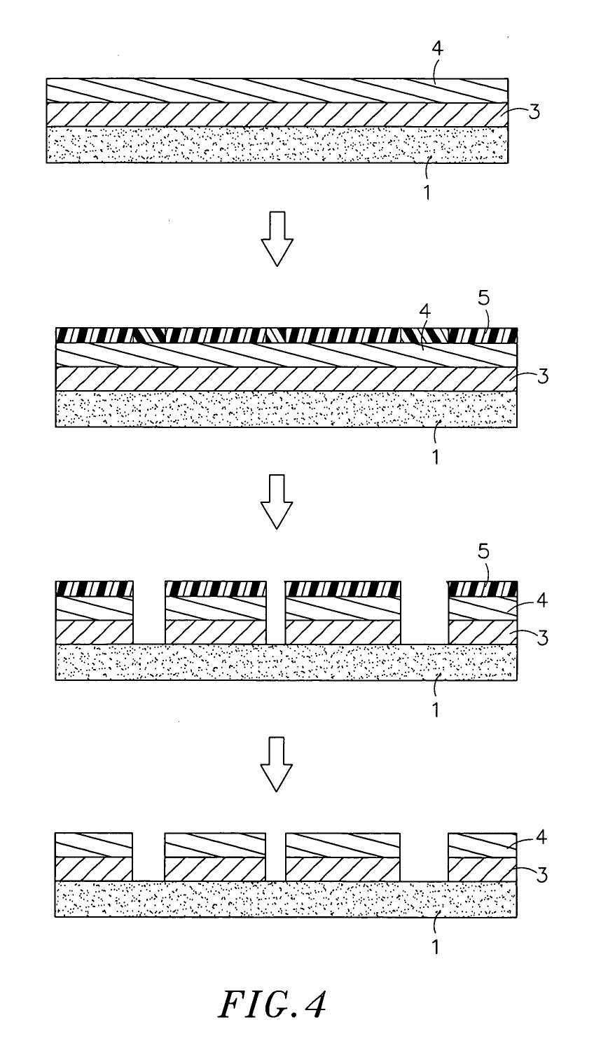

Referring to FIGS. 1, 2, 3 and 4, a ceramic substrate metallization process in accordance with the present invention comprises the steps of:
(100) clean the surface of a ceramic substrate 1 and then employ an etching technique to roughen the surface of the ceramic substrate 1;
(101) coat the surface of the ceramic substrate 1 with a layer of nanoscaled surface active agent 2 to modify the properties of the surface of the ceramic substrate 1;
(102) employ a coating technique to cover a first metal layer 3 on the nanoscaled surface active agent 2 for enabling the ceramic substrate 1 to carry the first metal layer 3;
(103) employ a coating technique to cover at least one second metal layer 4 on the first metal layer 3;
(104) bond a dry film 5 to the second metal layer 4;
(105) employ an etching technique to remove the dry film 5, the second metal layer 4 and the first metal layer 3 partially subject to a predetermined circuit pattern;
(106) remove the rest part of the dry film 5 and then coat the top surface of the patterned second metal layer 4 with a layer of nickel and then a layer of gold/silver, finishing the preparation of a circuit substrate.

The ceramic substrate 1 is an inorganic member without carrying any positive or negative charges. During the performance of the aforesaid ceramic substrate metallization process, the ceramic substrate 1 is washed with running pure water, for example, distilled water or filtered clean water, and then an etching technique is applied to the ceramic substrate 1 to roughen the surface of the ceramic substrate 1 for metal coating. Thereafter, the surface of the ceramic substrate 1 is coated with a layer of nanoscaled silicon-contained surface active agent 2, modifying the properties of the surface of the ceramic substrate 1 and forming a molecular film on the surface of the ceramic substrate 1 to lower the surface tension and to reduce the capillary attraction. The molecular film penetrates into and wets the ceramic substrate 1, avoiding formation of bubbles in further processing process. By means of the layer of nanoscaled silicon-contained surface active agent 2 to modify the properties of the surface of the ceramic substrate 1 and through activation of inorganic cations, SiO2 (silicon dioxide) surface is changed from a negative charge carrying status to positive charge carrying status, and then an anionic surfactant is bonded to achieve modification of the properties of the surface of the ceramic substrate 1. Organic modification is preferably achieved by means of:

SiOH+2Ca2+SiOCa++2H+

SiOCa++2e−→SiOCa+.e−

(Surface Organic Modification Reaction)

Therefore, the negatively charged nanoscaled surface active agent 2 at the ceramic substrate 1 attracts the positively charged first metal layer 3, forming a positive-negative charge attraction effect. Thus, the nanoscaled surface active agent 2 serves as a bonding medium between the ceramic substrate 1 and the positively charged first metal layer 3. Further, the aforesaid coating technique can be vacuum deposition, chemical vapor deposition, sputter deposition or chemical plating, enabling the first metal layer 3 of any of a variety of metal materials to be covered on the surface of the ceramic substrate 1.

During coating, the first metal layer 3 causes formation of a direct current or high frequency electric field on the modified ceramic substrate 1 that causes ionization of inert gas to produce discharge plasma so that high speed impact between ionized ions and electrons occurs, causing deposition of the metal molecules on the surface of the ceramic substrate 1. Thus, the first metal layer 3 is covered on the surface of the ceramic substrate 1 subject to the desired thickness. The thickness of the ceramic substrate 1 can be 0.01˜1 μm. The first metal layer 3 can be prepared from Si/Ni/Cr alloy, Fe/Co alloy or Fe/Co/Ni alloy.

It is to be understood that the nanoscaled surface active agent 2 can be negatively charged to attract positively charged first metal layer 3. Alternatively, the nanoscaled surface active agent 2 can be positively charged to attract negatively charged first metal layer 3. By means of a positive-negative charge attraction effect, the nanoscaled surface active agent 2 serves as a bonding medium to let first metal layer 3 be positively bonded to the ceramic substrate 1.

After coating of the first metal layer 3 on the ceramic substrate 1, a second metal layer 4 (prepared from copper or any other pure metal or metal alloy) is bonded to the first metal layer 3 by means of a coating technique, increasing the thickness of the metal materials on the ceramic substrate 1 and compacting the structure of the metal materials. Thus, different thicknesses of different metal materials can be bonded to the ceramic substrate 1 to fit different market requirements for different applications. There are no strict limitations on metal materials. Further, coating of the first metal layer 3 and the second metal layer 4 can be achieved by means of vacuum deposition, chemical vapor deposition, sputter deposition or chemical plating. It is not necessary to employ an expensive coating method. Therefore, the invention facilitates fabrication of ceramic circuit substrates and effectively lowers the fabrication cost.

Further, the dry film 5 to be bonded to the second metal layer 4 can be a photopolymer resin. A positive plate of photomask prepared subject to a predetermined circuit pattern is placed on the dry film 5 at the top side of the second metal layer 4, and then an exposing machine is operated to run vacuuming, pressuring and ultraviolet radiating steps. The ultraviolet radiating step is to radiate ultraviolet rays onto the dry film 5, causing photopolymerization of the dry film 5. Subject to masking effect of the photomask, ultraviolet rays do not reach the part corresponding to the predetermined circuit pattern so that a developer can be applied to etch the nonpolymerized part of the dry film 5 and the corresponding part of the first metal layer 3 and the second metal layer 4. By means of physical and chemical stripping techniques, the desired circuit pattern is produced. Further, because the second metal layer 4 is prepared from copper, it has high electrical conductivity and heat dissipation characteristics. After removal of residual dry film from the etched second metal layer 4, the patterned second metal layer 4 is coated with a layer of nickel and then a layer of gold, palladium or silver for high frequency application. The coated layer of nickel prohibits transfers of copper from the second metal layer 3 to the layer of gold, palladium or silver.

In actual practice, the ceramic substrate metallization process in accordance with the present invention has the following advantages and features:
1. Covering the nanoscaled surface active agent 2 on the surface of the ceramic substrate 1 allows deposition of a thin film of the first metal layer 3 on the surface of the ceramic substrate 1 to fit market requirements.
2. Covering the nanoscaled surface active agent 2 on the surface of the ceramic substrate 1 allows the first metal layer 3 prepared from any of a variety of metal materials to be formed on the surface of the ceramic substrate 1 by means of any of a variety of economic coating techniques including vacuum deposition, chemical vapor deposition, sputter deposition and chemical plating, saving the fabrication cost.
3. After coating of the first metal layer 3 on the ceramic substrate 1, at least one second metal layer 4 prepared from one of a series of metal materials or their alloys is coated on the first metal layer 3 by means of any of a variety of coating techniques to fit market requirements. A wide range of metal materials can be selectively used for the at least one second metal layer 4 to satisfy different requirements for different applications.

In conclusion, the invention is to coat the surface of the non-charged ceramic substrate 1 with a layer of nanoscaled surface active agent 2 to form a positively charged or negatively charged surface layer for the deposition of a thin film of first metal layer 3 and the deposition of at least one second metal layer 4 on the first metal layer 3 after the first metal layer has been etched subject to a predetermined circuit pattern. Thus, the invention allows preparation of different ceramic circuit substrates practically and economically to satisfy different requirements for different applications.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A ceramic substrate metallization process for forming a thin film of metal on the surface of a ceramic substrate, comprising the steps of:
(a) cleaning a prepared ceramic substrate with running water and then employing an etching technique to roughen the surface of said ceramic substrate;
(b) coating a negatively charged nanoscaled surface active agent on the roughened surface of said ceramic substrate; and
(c) employing a coating technique to coat a positively charged first metal layer on said ceramic substrate.

2. The ceramic substrate metallization process as claimed in claim 1, further comprising the steps of:
(d) employing a coating technique to coat a second metal layer on said positively charged first metal layer after complete of step (c);
(e) bonding a dry film on said second metal layer and then etching said dry film, said second metal layer and said first metal layer subject to a predetermined circuit pattern, and then removing the residual dry film from the patterned second metal layer; and
(f) employing a coating technique to coat a metal material on said patterned second metal layer subject to a predetermined thickness.

3. The ceramic substrate metallization process as claimed in claim 1, wherein the etching technique employed to roughen the surface of said ceramic substrate is a microetching technique.

4. The ceramic substrate metallization process as claimed in claim 1, wherein the running water used to clean said ceramic substrate is pure distilled water.

5. The ceramic substrate metallization process as claimed in claim 1, wherein said nanoscaled surface active agent is a nanoscaled silicon-contained surface active agent.

6. The ceramic substrate metallization process as claimed in claim 1, wherein said first metal layer has a thickness within 0.01˜1 μm.

7. The ceramic substrate metallization process as claimed in claim 1, wherein said first metal layer is prepared from a metal alloy group of Si/Ni/Cr alloy, Fe/Co alloy and Fe/Co/Ni alloy.

8. A ceramic substrate metallization process for forming a thin film of metal on the surface of a ceramic substrate, comprising the steps of:
(a) cleaning a prepared ceramic substrate with running water and then employing an etching technique to roughen the surface of said ceramic substrate;
(b) coating a positively charged nanoscaled surface active agent on the roughened surface of said ceramic substrate; and
(c) employing a coating technique to coat a negatively charged first metal layer on said ceramic substrate.

9. The ceramic substrate metallization process as claimed in claim 8, further comprising the steps of:
(d) employing a coating technique to coat a second metal layer on said negatively charged first metal layer after complete of step (c);
(e) bonding a dry film on said second metal layer and then etching said dry film, said second metal layer and said first metal layer subject to a predetermined circuit pattern, and then removing the residual dry film from the patterned second metal layer; and
(f) employing a coating technique to coat a metal material on said patterned second metal layer subject to a predetermined thickness.

10. The ceramic substrate metallization process as claimed in claim 8, wherein the etching technique employed to roughen the surface of said ceramic substrate is a microetching technique.

11. The ceramic substrate metallization process as claimed in claim 8, wherein the running water used to clean said ceramic substrate is pure distilled water.

12. The ceramic substrate metallization process as claimed in claim 8, wherein said nanoscaled surface active agent is a nanoscaled silicon-contained surface active agent.

13. The ceramic substrate metallization process as claimed in claim 8, wherein said first metal layer has a thickness within 0.01˜1 μm.

14. The ceramic substrate metallization process as claimed in claim 8, wherein said first metal layer is prepared from a metal alloy group of Si/Ni/Cr alloy, Fe/Co alloy and Fe/Co/Ni alloy.
